(19) United States
(12) Patent Application Publication
(10) Pub. No.: US 2016/0119525 A1
(43) Pub. Date: Apr. 28, 2016

(54) IMAGE PROCESSING METHODS AND SYSTEMS BASED ON FLASH

(71) Applicant: Samsung Electronics Co., Ltd., Suwon-Si (KR)

(72) Inventor: Aya WOLF, Ramat Gan (IL)

(21) Appl. No.: 14/520,943

(22) Filed: Oct. 22, 2014

(51) Int. Cl. H04N 5/235; H04N 5/376; G03B 15/05

(52) U.S. Cl. CPC H04N 5/2354; G03B 15/05; H04N 5/3765

(57) ABSTRACT

At least one example embodiment discloses an image processing system including an image sensor configured to generate image data for a pre-flash frame and a main flash frame and a processor configured to generate a weight matrix based on the pre-flash frame, the weight matrix identifying corresponding brightness values in the pre-flash frame, the processor further configured to adjust at least one of a foreground and a background of the main flash frame based on the weight matrix.

### BACKGROUND

A digital camera includes an image sensor to generate an electronic image. Common image sensors may include a Charge Coupled Device (CCD) image sensor, a CMOS Image Sensor (CIS), and so on. An image sensor includes pixels arranged in a two-dimension array.

The image sensor receives light during particular time to obtain an appropriate image signal. The time for receiving the light is referred to as exposure time. To obtain an image having a brightness and high signal-to-noise ratio (SNR), the exposure time is adjusted based on brightness of environment where an image is captured. The digital camera has such an automatic exposure (AE) adjustment function for automatically adjusting the exposure time according to brightness of the environment where an image is captured.

A problem arises when an image is captured in an environment where the light is insufficient. An image captured in such environment where the light is insufficient does not represent the object appropriately. In general, to solve such a problem, a flash emitting artificial light, such as a light emitting diode (LED) is used. It is possible to capture an image with sufficient brightness by emitting the light around the object through the flash. When the flash is used, the image sensor receives sufficient light during short exposure time. Moreover, automatic white balancing (AWB) may be used to apply white balancing functions to the captured image.

### SUMMARY

Under flash illumination, the exposure and the white balance gains are adjusted. However, for the traditional AE to converge while the flash is ON, this process is lengthy and wastes unnecessary battery time. AE measures overall brightness of the current frame and adjusts exposure so that the brightness of the image will be satisfactory while maintaining a good contrast ratio. Since the scene is unknown, the initial “guess” of AE might not be optimal and it takes several frames to reach a stable state where the chosen exposure results in good brightness and contrast levels. Moreover, the AWB algorithm aims to balance the colors in the whole image. Usually, when using flash, only the object being photographed is expected to have correct colors.

Some methods use pre-flash frames and compare them to a frame without flash. However, these methods are based on the traditional way in which the image brightness is measured. The traditional AE grid for measuring the frame's brightness uses a fixed weighting scheme (for example, in the form of a triangle), where more weight is given to areas in the image which reside inside a fixed location (for example within the middle of the triangle). The fixed weighting scheme for computing the brightness is based on the assumption of the expected shape of the object being photographed (a person, a statue, or landscape on the other hand, and so forth). No fixed weighting scheme can match the true object in the scene with 100% certainty. As a result, a close object lit by flash might be burned and have incorrect white balance, while the background will be too dark.

At least one example embodiment discloses methods and systems for generating a flash.

At least one example embodiment discloses an image processing system including an image sensor configured to generate image data for a pre-flash frame and a main flash frame and a processor configured to generate a weight matrix based on the pre-flash frame, the weight matrix identifying corresponding brightness values in the pre-flash frame, the processor further configured to adjust at least one of a foreground and a background of the main flash frame based on the weight matrix.

In an example embodiment, the processor is configured to determine a flash intensity for the main flash frame.

In an example embodiment, the processor is configured to determine a calibrated white point and an ambient white point after determining the flash intensity.

In an example embodiment, the processor is configured to determine a weighted average of the calibrated white point and the ambient white point.

In an example embodiment, the processor is configured to determine a white point balance gain based on the weighted average.

In an example embodiment, the processor is configured to determine a brightness from the background and a brightness for the foreground based on the weight matrix.

In an example embodiment, the processor is configured to increase an exposure of the main flash frame and reduce a flash intensity for the main flash frame.

In an example embodiment, the weight matrix outlines an object in the pre-flash frame.

At least one example embodiment discloses a method of image processing. The method includes generating image data for a pre-flash frame and image data for a main flash frame, generating a weight matrix based on the pre-flash frame, the weight matrix identifying corresponding brightness values in the pre-flash frame and adjusting at least one of a foreground and a background of the main flash frame based on the weight matrix.

In an example embodiment, the method further includes determining a flash intensity for the main flash frame.

In an example embodiment, the method further includes determining a calibrated white point and an ambient white point after determining the flash intensity.

In an example embodiment, the method further includes determining a weighted average of the calibrated white point and the ambient white point.

In an example embodiment, the method further includes determining a white point balance gain based on the weighted average.

In an example embodiment, the method further includes determining a brightness from the background and a brightness for the foreground based on the weight matrix.

In an example embodiment, the method further includes increasing an exposure of the main flash frame and reducing a flash intensity for the main flash frame.

In an example embodiment, the weight matrix outlines an object in the pre-flash frame.

### BRIEF DESCRIPTION OF THE DRAWINGS

Example embodiments will become more appreciable through the description of the drawings in which:

FIG. 1 is a block diagram of an image processing device including an image signal processor according to an example embodiment;

FIG. 2 illustrates is a detailed block diagram of the image sensor illustrated in FIG. 1;

FIG. 3 illustrates an example embodiment of a camera controller and the image signal processor illustrated in the image sensing system of FIG. 1;

FIG. 4 illustrates a method of flash processing according to an example embodiment;

FIGS. 5A-5B illustrate a method of generating a weight matrix according to an example embodiment;

FIG. 6A illustrates a conventional image;

FIG. 6B illustrates an image processed according to an example embodiment; and

FIG. 7 a block diagram illustrating a digital imaging system according to an example embodiment.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., digital single lens reflex (DSLR) cameras, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Under flash illumination, the exposure and the white balance gains are adjusted. However, for the traditional AE to converge while the flash is ON, this process is lengthy and wastes unnecessary battery time. AE measures overall brightness of the current frame and adjusts exposure so that the brightness of the image will be satisfactory while maintaining a good contrast ratio. Since the scene is unknown, the initial “guess” of AE might not be optimal and it takes several frames to reach a stable state where the chosen exposure results in good brightness and contrast levels. Moreover, the AWB algorithm aims to balance the colors in the whole image. Usually, when using flash, only the object being photographed is expected to have correct colors.

Moreover, some methods use pre-flash frames and compare them to a frame without flash. However, these methods are based on AE matrix for measuring the frame's brightness. As a result, a close object lit by flash might be burned and have incorrect white balance, while the background will be too dark.

As a result, example embodiments provide methods and systems for reducing these issues.

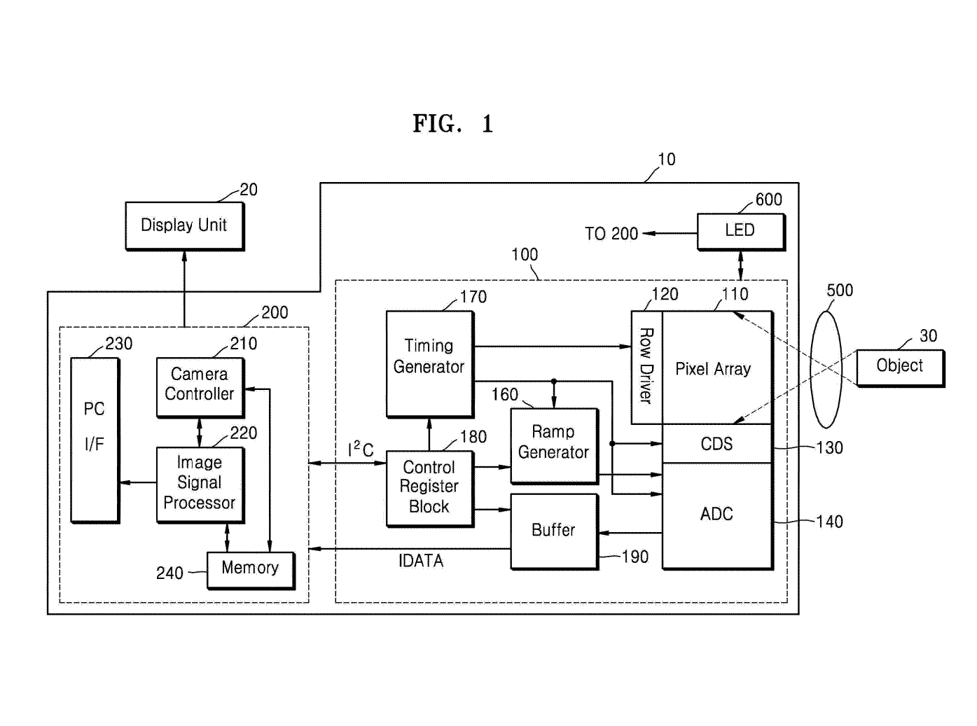

FIG. 1 is a schematic block view of an image processing device according to an example embodiment. Referring to FIG. 1, an image processing device 10 may be embodied in a portable electronic device such as a digital camera, a mobile phone, a smart phone, a tablet personal computer (PC), a personal digital assistant (PDA), a mobile internet device (MID), or a wearable computer or another electronic device (e.g., laptop computer, etc.) including, associated with or connected to a camera.

The image processing device 10 includes a CMOS image sensor 100, a digital signal processor (DSP) 200, a display 300, an optical lens 500 and light emitting element 600. The light emitting element 600 may be referred to as a flash and may be a light emitting diode (LED). However, the light emitting element 600 is not limited thereto and may be used with any type of flash, for example Xenon.

According to an example embodiment, the image processing device 10 may not include the optical lens 500. Moreover, it should be understood that the image processing device 10 is not limited to the features shown in FIG. 1. For example, the image processing device 10 may include a shutter.

The CMOS image sensor 100 may generate image data IDATA for a subject incident through the optical lens 500. The CMOS image sensor 100 may be embodied in a backside illumination (BSI) image sensor, but is not limited thereto.

The CMOS image sensor 100 may include an active pixel sensor array 110, a row driver 120, a correlated double sampling (CDS) block 130, an analog-to-digital converting (ADC) block 140, a ramp generator 160, a timing generator 170, a control register block 180, and a buffer 180.

The CMOS image sensor 100 may sense an image of the subject 30 captured or incident through the optical lens 500, and generate image data IDATA corresponding to a result of the sensing.

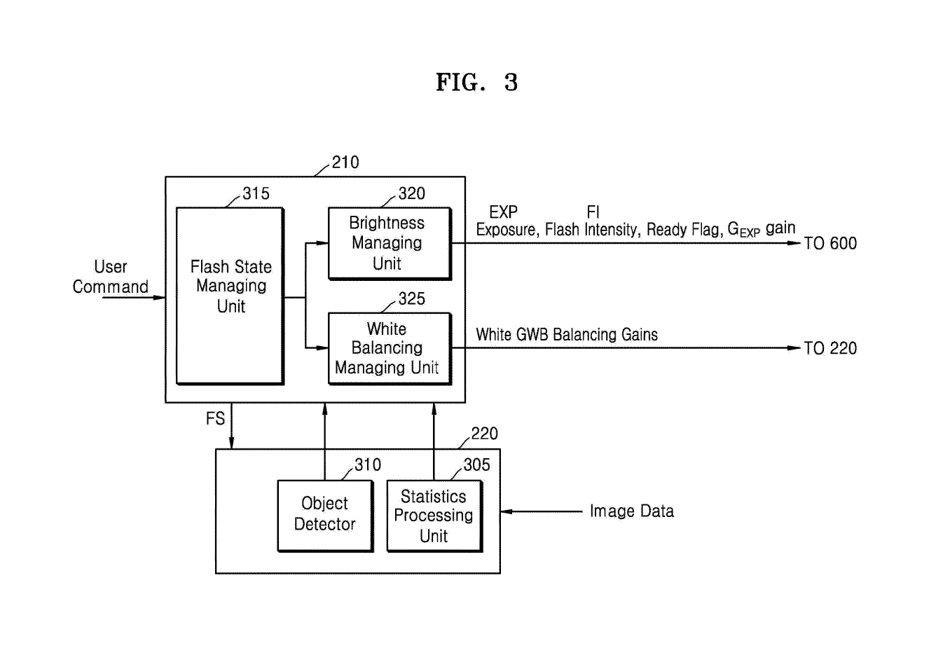

The active pixel sensor array 110 includes a plurality of pixels 111 arranged in an array of rows and columns. As discussed herein, rows and columns may be collectively referred to as lines. Each of a plurality of read and reset lines corresponds to a line of pixels in the pixel array 110. In FIG. 3, each pixel may be an active-pixel sensor (APS).

Although example embodiments may be discussed herein with regard to lines (e.g., rows and/or columns) of a pixel array, it should be understood that the same principles may be applied to pixels grouped in any manner.

The row driver 120 may generate control signals which may control an operation of each of a plurality of pixels included in the active pixel sensor array 110. The CDS block 130 may perform a correlated double sampling operation on a pixel signal output from each of the plurality of pixels using a ramp signal output from the ramp generator 160, and output a correlated double sampled pixel signal. The ADC block 140 may convert each of the correlated double sampled pixel signals into each digital signal by the CDS block 130.

The timing generator 160 may control the row driver 120, the CDS block 130, the ADC block 140, and/or the ramp generator 160 based on output signals of the control register block 180.

The control register block 180 may store control bits which may control an operation of the timing generator 170, the ramp generator 160, and/or the buffer 190. The buffer 190 may buffer digital signals output from the ADC block 140 and generate image data IDATA according to a result of the buffering. A DSP 200 may output image signals corresponding to the image data IDATA output from the CMOS image sensor 100 to a display 300.

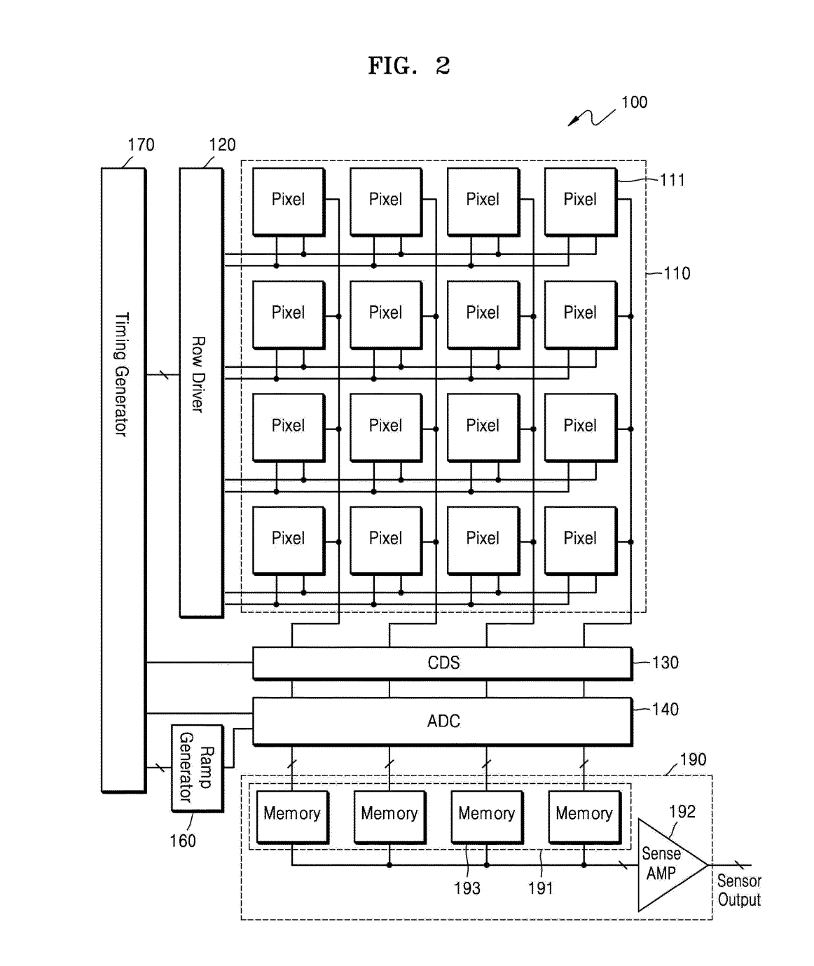

FIG. 2 illustrates FIG. 2 is a detailed block diagram of the image sensor 100 illustrated in FIG. 1. Referring to FIG. 2, the image sensor 100 includes the pixel array 110, the row driver 120, the CDS circuit 130, the ADC 140, the reference generator 160, the timing generator 170, and the buffer 190.

The pixel array 110 includes the plurality of pixels 111 arranged in a matrix form, each of which is connected to one of a plurality of row lines and one of a plurality of column lines. Each of the pixels 111 may include a red filter which passes light in the red spectrum, a green filter which passes light in the green spectrum, and a blue filter which passes light in the blue spectrum. According to another example embodiment of inventive concepts, each of the pixels 111 may include a cyan filter, a magenta filter, and a yellow filter.

The row driver 120 may decode a row control signal (e.g., an address signal) generated by the timing generator 170 and select at least one row line from among the row lines included in the pixel array 110 in response to a decoded row control signal.

The CDS circuit 130 may perform CDS on a pixel signal output from a pixel 111 connected to one of the column lines in the pixel array 110. The ADC 140 may output a result signal using reference signals received from the ramp generator 160 and a CDS signal received from the CDS circuit 130, count the result signal, and output a count result to the buffer 190. The ramp generator 160 may operate based on a control signal generated by the timing generator 170.

The buffer 190 includes a column memory block 191 and a sense amplifier 192. The column memory block 191 includes a plurality of memories 193.

Each memory 193 may operate in response to a memory control signal generated by a memory controller (not shown) positioned within the column memory block 191 or the timing generator 170 based on a control signal generated by the timing generator 170. The memory 193 may be implemented as SRAM.

In response to the memory control signal, the column memory block 191 receives and stores a digital signal output from the ADC 140. Digital signals stored in the respective memories 193 are amplified by the sense amplifier 192 and output as image data.

Referring back to FIG. 1, the DSP 200 includes an image signal processor (ISP) 210, a camera controller 220, an interface (I/F) 230 and a memory 240.

The ISP 210 receives the image data IDATA output from the buffer 180, processes the received image data IDATA to be visible to people, outputs the processed image data to the display 300 through the I/F 230 and/or stores the generated image in the memory 240. The DSP 200 may also store image data IDATA in the memory 240.

The memory 240 may be any well-known non-volatile memory and/or combination of volatile and non-volatile memories. Because such memories are well-known, a detailed discussion is omitted.

The camera controller 220 controls an operation of the control register block 170. The camera controller 220 controls an operation of the CMOS image sensor 100, e.g., the control register block 170, using a protocol, e.g., an inter-integrated circuit (I2C); however, example embodiments are not limited thereto.

In FIG. 1, it is illustrated that the ISP 210 is embodied in the DSP 200, however the ISP 210 may be embodied in the CMOS image sensor 100 according to an example embodiment. Moreover, the CMOS image sensor 100 and the ISP 210 may be embodied in one package, e.g., a multi-chip package (MCP) or a package on package (PoP).

FIG. 3 illustrates an example embodiment of the camera controller 210 and the image signal processor 220 illustrated in the image sensing system of FIG. 1.

As shown, the image signal processor 220 includes a statistics processing unit 305 and an object detector 310 and the camera controller 210 includes a flash state managing unit 315, a brightness managing unit 320 and a white balancing manager 325.

As should be understood, flash intensity is the amount of voltage to the flash module whereas flash brightness is the measured image brightness for a scene lit only by flash.

The statistics processing unit 305, object detector 310, flash state managing unit 315, brightness managing unit 320 and white balancing manger 325 may be hardware, firmware, hardware executing software or any combination thereof. When at least one of statistics processing unit 305, object detector 310, flash state managing unit 315, brightness managing unit 320 and white balancing manger 325 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the at least one of the statistics processing unit 305, object detector 310, flash state managing unit 315, brightness managing unit 320 and white balancing manger 325. CPUs, DSPs, ASICs and FPGAs may generally be referred to as processors and/or microprocessors.

In the event where at least one statistics processing unit 305, object detector 310, flash state managing unit 315, brightness managing unit 320 and white balancing manger 325 is a processor executing software, the processor is configured as a special purpose machine to execute the software to perform the functions of the at least one of statistics processing unit 305, object detector 310, flash state managing unit 315, brightness managing unit 320 and white balancing manger 325. In such an embodiment, the processor may include one or more Central Processing Units (CPUs), digital signal processors (DSPs), application-specific-integrated-circuits (ASICs), field programmable gate arrays (FPGAs) computers and may be the image signal processor 220 and/or the camera controller 210.

The flash state managing unit 315 receives a user command and initiates flash processing based on the user's command and the flash mode. For example, the flash mode is determined in advanced. The flash mode may be OFF, ON or AUTO. The flash state managing unit 315 then provides flash instructions FS to the image signal processor 220, the brightness managing unit 320 and the white balancing manager 325 to indicate flash processing. The flash processing is initiated upon a trigger request (when capturing an image) from the user when flash is not OFF. In AUTO mode, the flash processing is initiated if it is determined that the flash is to be used for the scene. In ON mode, the flash processing is always initiated.

While the flash state managing unit 315 is illustrated as a single state, it should be understood that the camera controller may include two separate asynchronous state machines, one that sets the pre-flash frame(s) and one the handles reading statistics and setting values to the sensor.

The flash processing includes using at least one pre-flash frame and comparing the at least one pre-flash frame to a frame without flash. For example, when the flash state managing unit 315 receives a capture request from the user, the flash state managing unit may send requests for one or more consecutive pre-flash frames with varying linear exposure indexes (LEIS) to the light emitting element 600 and the image sensor 100, through the brightness managing unit 320. An LEI is the product of the exposure and gain. As described, the behavior of the flash is set by the camera control 20 upon a capture (which happens during a capture frame request).

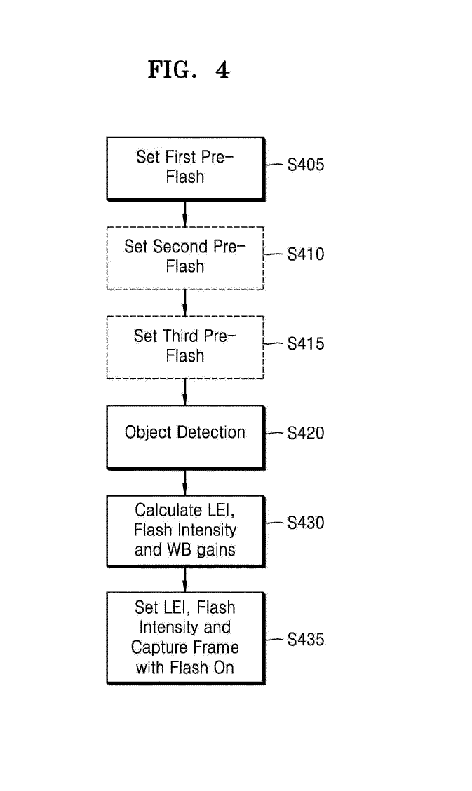

An example of flow chart the flash processing is shown in FIG. 4, which is described in conjunction with FIG. 3.

In a mode where flash is required, the flash state managing unit 315 sets a first pre-flash frame at S405. The first pre-flash frame settings may be stored in the memory 240 or dynamically determined by the camera controller 210 and the image signal processor 220. In other example embodiments, the flash state managing unit 315 may set a second pre-flash frame at S410 and a third pre-flash frame at S415. However, it should be understood that S410 and S415 are optional and the method may be performed using only the first pre-flash frame.

The image sensor 100 and/or the light emitting element 600 receive the first pre-flash frame request including a first LEI setting from the camera controller 210. The camera controller is given requests from the flash algorithm as to flash intensity, exposure, and gains for the first pre-flash and all following pre-flashes.

For each LEI setting of each pre-flash, the pre-flash intensity is the same. The flash algorithm does not control the separation of LEI into exposure and gains. If a flash driver is in the image sensor 100, the brightness manager 320 sends the request (including exposure EXP, flash intensity FI, gain G_{EXP} and ready flag) to the image sensor 100, which then sends the settings to the light emitting element 600. If the flash driver is in the image light emitting element 600, the brightness manger 320 sends the request (including exposure EXP, flash intensity FI, gain G_{EXP} and ready flag) to the light emitting element 600.

The first LEI setting may be the same LEI as a current ambient setting or smaller. The current ambient setting may be stored in the memory 240 or provided by the statistics processing unit 305.

Ambient frame statistics are gathered by the statistics processing unit 305 for each frame when flash is not operating, in preparation for flash processing. For each pre-flash frame, the statistics processing unit 305 calculates the brightness, which is a grid of between 8×8 and 32×32 brightness values over the frame. Consequently, at S420, the statistics processing unit 305 collects data regarding image data produced as a result of the first LEI setting. In example embodiments where more than one pre-flash is used, the statistics processing unit 305 performs similar computations for each pre-flash frame.

At S420, the object detector 310 performs object detection. More specifically, on the arrival of the first pre-flash frame, the object detector 310 calculates a weight matrix, which outlines a location of an object lit by the flash.

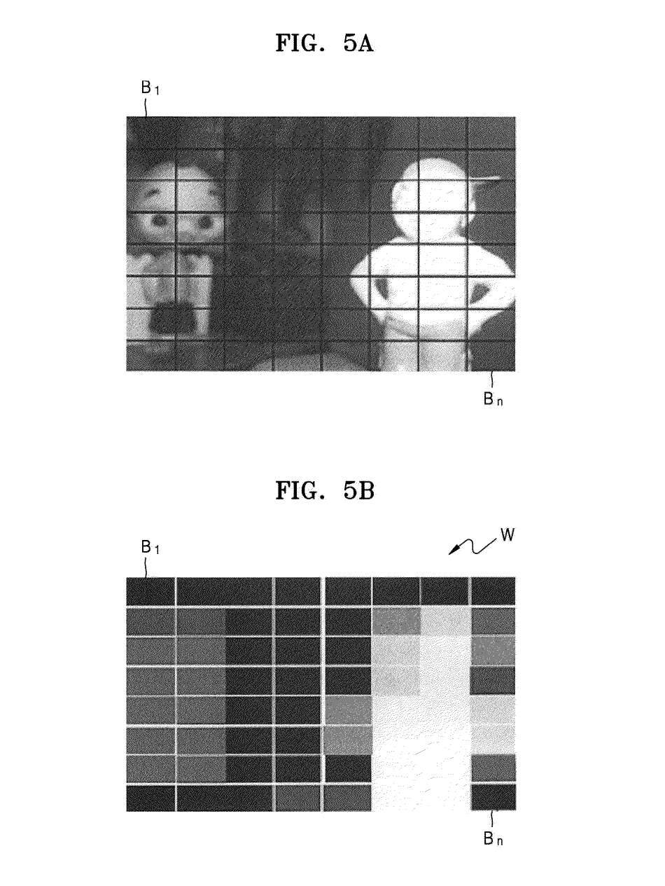

FIGS. 5A-5B illustrate how the weight matrix is generated by the object detector. The object detector 310 divides the frame from the first pre-flash into a grid having a plurality of blocks B₁-Bₙ, which is shown in FIG. 5A. The object detector 310 also divides the ambient frame into a grid having the plurality of blocks B₁-Bₙ.

For each block B₁-Bₙ, the object detector 310 calculates a ratio of the pre-flash brightness to the ambient brightness, and generates a weight matrix W, which is shown in FIG. 5B. Objects which are closer to the image sensor 100 have higher values when lit by flash, whereas objects further away from the image sensor 100 have lower values.

The weight calculation performed by the object detector is a division, after incorporating LEI changes and other corner cases, resulting in a flash-induced weight matrix as opposed to the traditional weight matrix used by AE to calculate brightness. As described above, and in contrast to example embodiments, AE uses fixed weights. In an example embodiment, the controller 210 uses weights calculated on the first pre-flash.

Referring back to FIG. 4, it should be understood that method of FIG. 4 operates by making sequential requests to the light emitting element 600 and the image sensor 100. The pre-flash and flash frames arrive in the same sequential order but are not synchronized with the requests.

After all the pre-flashes' statistics are processed, at S430, the brightness managing unit 320 calculates the exposure EXP, flash intensity FI and gain G_{EXP} for the flash based on the collected data from the statistics processing unit 305. At S430, a pre-flash frame is selected to compute the desired exposure for the main flash frame. Alternatively, the camera controller 210 chooses two pre-flash frames which exhibit brightness closest to the target brightness, and calculates an exposure as a weighted sum of the exposures of these frames.

Moreover, the white balancing managing unit 325 determines white balancing gains G_{WB} for the image signal processor 220. The true white point of the frame is determined because the flash is ON and the flash module's white balance point is known from calibration. Moreover, since the weight matrix is used, the white balancing managing unit 325 generates a correct white balance for the object

Traditional white balance can only “guess” the type of illumination in the scene. However, in example embodiments, when the flash is ON, the type of illumination and its effect on the white point is known (by calibrating the flash module in advance), which is useful when considering the object lit by flash.

The brightness managing unit 320 may determine the LEI for the main flash frame using numerous methods. For example, the brightness managing unit 320 may select a pre-flash frame to compute the LEI for the main flash frame or the brightness managing unit 320 may select two pre-flash frames which exhibit a brightness closest to a target brightness and calculate the LEI as a weighted sum of the LEIS of the selected pre-flash frames. The target brightness is a parameter set based on empirical data.

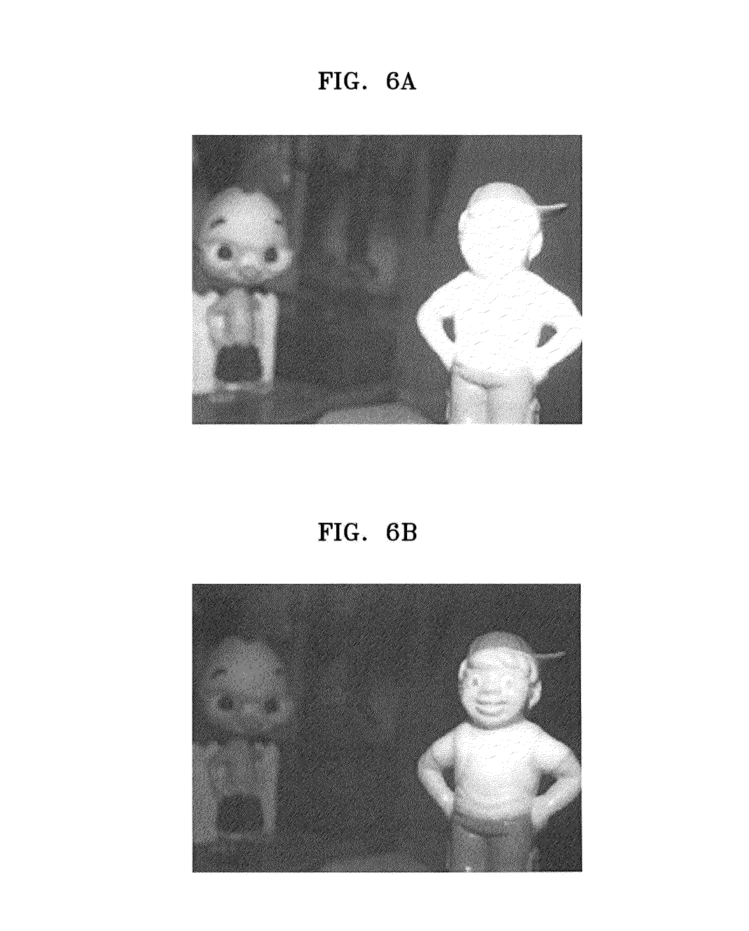

Conventional methods use an average brightness of a whole frame (as done in AE) to determine the LEI from the main flash frame. However, if the whole frame is taken into account, the calculated LEI aims to bring the average brightness of the whole frame to the desired target brightness, resulting in a burned object, which is shown in FIG. 6A.

To reduce the burning, the brightness managing unit 320 utilizes the weight matrix to enhance the foreground of the image. A result is shown in FIG. 6B. Using the weight matrix, the camera controller 210 can calculate two separate brightness measures, one for the background and one for the foreground. Once the camera controller 210 calculates a selected LEI when using the maximal flash brightness, the camera controller 210 performs a tradeoff between flash brightness (strength) and exposure (LEI). Specifically, the camera controller 210 increases LEI so that the background is more lit, without adding noise (gains), while reducing flash brightness, while keeping the foreground lit enough.

The brightness of each frame is calculated as a weighted sum of the brightness values in each cell of the grid (e.g., between 8×8 and 32×32). The brightness values of each cell in the grid are read from the statistics processing unit 305, the weight is calculated by the flash algorithm by dividing the brightness with flash by the brightness without flash.

In other words, the brightness of each frame is a sum of products of the weight for a cell and a brightness of the cell divided by a sum of the weights.

To reach a certain target brightness, the overall brightness of a scene may be considered a sum of the ambient brightness and the flash induced brightness.

The brightness managing unit 320 subtracts the ambient measured brightness from the pre-flash measured brightness and then gets the “pure” flash brightness (to eliminate the influence of a possible additional light source in the scene). If the brightness is too large (too small), the brightness managing unit 320 can reduce (increase) the exposure thereby reducing (increasing) the ambient component.

Since the intensity of the pre-flash is sometimes less than a maximal possible intensity (during auto focus convergence, for example, the flash is turned ON at half intensity, and it is only turned to maximal intensity during the actual capture of the frame), the brightness managing unit 320 can calculate the expected brightness of a full-flash using the pre-calibrated brightness and the measured pure brightness.

Additionally, the brightness managing unit 320 may determine a flash intensity FI. By changing the flash intensity FI, the flash intensity reduces the LEI so as not to burn the object, and therefore, the background might not be visible at all. However, by reducing the flash intensity, the LEI can be increased and the background is visible. Assuming the flash induced brightness Br(Flash) to be linear, then:

Br(Total)=BR(LEI)*Br(Flash)=Br(Exposure)*Br(gains)*Br(Flash) (1)

where Br(EXP) is the exposure induced brightness and Br(G_{EXP}) is the gain induced brightness. This is done while limiting the amount of gains in order to maintain high SNR (gains add noise).

Since the brightness managing unit 320 computes a LEI for full-flash intensity, as described above, the brightness managing unit 320 can limit the Br(Flash) reduction by the scale to the exposure induced brightness Br(EXP) is increased. Additionally, the brightness managing unit 320 can also have a threshold on the allowed gains with and increase Br(gains) according to the threshold.

After the LEI for the flash frame and the flash intensity FI have been determined by the brightness managing unit 320, the white balancing managing unit 325 calculates white balance gains for a flash lit image.

The white balancing managing unit 325 calculates a weighted average of the white point of the scene's ambient image and the calibrated white point of the flash. The white balance is computed after the brightness managing unit 320 determines the flash intensity and LEI for the scene, and the brightness managing unit 320 uses the flash intensity and LEI to determine the weight between the ambient and the flash white points. The weight used for the averaging is set according to an expected relative contribution of the flash to the average brightness of the foreground object.

A novel feature of the present application is weighting between a calibrated flash module white point and measured ambient white point (WP) (the ambient white point is taken from a frame for which the flash was OFF). Computing the white point using the calculated “pure” flash brightness is accurate since the exact white point from the calibrated white point of the flash module is available from memory. Example embodiments separate the calculation for pure flash WP and ambient WP. The actual calculation of the white balance gains is done using any known method.

The average brightness for different flash intensities may be determined from empirical data based on a set of frames with fixed exposure and varying flash intensities.

The flash induced brightness for a specific flash intensity, can be used by selecting the measured brightness values for a flash intensity value higher than the specific flash intensity and a flash intensity value lower than the specific flash intensity and performing a weighted average of the measured brightness between two flash intensities. Alternatively, due to the brightness linearity, the line parameters can be recorded and used to compute it directly.

Different calibrated white points (red and blue) for different flash intensities may be determined and stored by the white balancing unit 325. In order to know the white point value for a specific flash intensity, the white balancing unit 325 performs a weighted average between the two nearest flash intensity values that are stored in the white balancing unit 325. The white balancing unit 325 may include a storage medium or use the memory 240 to store the white points and corresponding flash intensities.

Therefore, once the brightness managing unit 320 determines the flash intensity FI, the white balancing managing unit 325 determines corresponding white point balancing gains G_{WB}. The white balancing managing unit 325 provides the corresponding white point balancing gains G_{WB} to the image signal processor 220.

Given the ambient white point and the flash white point (calculated as explained above), the white balancing managing unit 325 computes the weighted white point. The weight is calculated as explained above. Then the white balance gains are calculated from the weighted white point using any known method.

Referring back to FIG. 4, the LEI, flash intensity and white balance gains are set by the camera controller 210 and the camera then captures a frame with the flash ON using the set LEI, flash intensity and white balance gains, at S435.

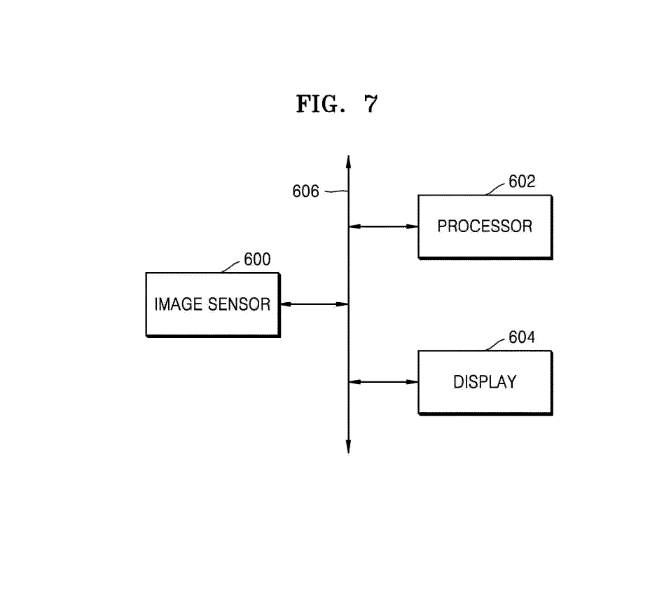

FIG. 7 is a block diagram illustrating a digital imaging system according to an example embodiment.

Referring to FIG. 7, a processor 602, an image sensor 600, and a display 604 communicate with each other via a bus 606. The processor 602 is configured to execute a program and control the digital imaging system. The image sensor 600 is configured to capture image data by converting optical images into electrical signals. The image sensor 600 may be an image sensor as described above with regard to FIG. 1. The processor 602 may include the image signal processor 220 shown in FIG. 1, and may be configured to process the captured image data for storage in a memory (not shown) and/or display by the display unit 604. The digital imaging system may be connected to an external device (e.g., a personal computer or a network) through an input/output device (not shown) and may exchange data with the external device.

For example, the digital imaging system shown in FIG. 7 may embody various electronic control systems including an image sensor (e.g., a digital camera), and may be used in, for example, mobile phones, personal digital assistants (PDAs), laptop computers, netbooks, tablet computers, MP3 players, navigation devices, household appliances, or any other device utilizing an image sensor or similar device.

The foregoing description of example embodiments has been provided for purposes of illustration and description. It is not intended to be exhaustive or limiting. Individual elements or features of a particular example embodiment are generally not limited to that particular example embodiment. Rather, where applicable, individual elements or features are interchangeable and may be used in a selected embodiment, even if not specifically shown or described. The same may also be varied in many ways. All such modifications are intended to be included within the scope of this disclosure.

1. An image processing system comprising:
an image sensor configured to generate image data for a pre-flash frame and a main flash frame; and
a processor configured to generate a weight matrix based on the pre-flash frame, and configured to adjust at least one of a foreground and a background of the main flash frame based on the weight matrix, and the processor further configured to divide the pre-flash frame into a plurality of blocks,
wherein the weight matrix identifies a corresponding brightness value of each of the plurality of blocks.

2. The image processing system of claim 1, wherein the processor is configured to determine a flash intensity for the main flash frame.

3. The image processing system of claim 2, wherein the processor is configured to determine a calibrated white point and an ambient white point after determining the flash intensity.

4. The image processing system of claim 3, wherein the processor is configured to determine a weighted average of the calibrated white point and the ambient white point.

5. The image processing system of claim 4, wherein the processor is configured to determine a white point balance gain based on the weighted average.

6. The image processing system of claim 1, wherein the processor is configured to determine a brightness from the background and a brightness for the foreground based on the weight matrix.

7. The image processing system of claim 6, wherein the processor is configured to increase an exposure of the main flash frame and reduce a flash intensity for the main flash frame.

8. The image processing system of claim 1, wherein the weight matrix outlines an object in the pre-flash frame.

9. A method of image processing, the method comprising:
generating image data for a pre-flash frame and image data for a main flash frame;
dividing the pre-flash frame into a plurality of blocks;
generating a weight matrix based on the pre-flash frame, the weight matrix identifying a corresponding brightness values of each of the plurality of blocks; and
adjusting at least one of a foreground and a background of the main flash frame based on the weight matrix.

10. The method of claim 9, further comprising:
determining a flash intensity for the main flash frame.

11. The method of claim 10, further comprising:
determining a calibrated white point and an ambient white point after determining the flash intensity.

12. The method of claim 11, further comprising:
determining a weighted average of the calibrated white point and the ambient white point.

13. The method of claim 12, further comprising:
determining a white point balance gain based on the weighted average.

14. The method of claim 9, further comprising:
determining a brightness from the background and a brightness for the foreground based on the weight matrix.

15. The method of claim 14, further comprising:
increasing an exposure of the main flash frame; and
reducing a flash intensity for the main flash frame.

16. The method of claim 9, wherein the weight matrix outlines an object in the pre-flash frame.

17. An image processing system comprising,
an image sensor configured to generate image data for a pre-flash frame and a main flash frame; and
a processor configured to generate a weight matrix based on the pre-flash frame, the weight matrix identifying corresponding brightness values in the pre-flash frame, the processor further configured to adjust at least one of a foreground and a background of the main flash frame based on the weight matrix,
wherein the processor is configured to determine a calibrated white point and an ambient white point after determining a flash intensity for the main flash frame and is configured to determine a weighted average of the calibrated white point and the ambient white point based on a linear exposure index.

18. The image processing system of claim 17, wherein the processor is configured to adjust the background of the main flash frame based on the weight matrix.

19. The image processing system of claim 1, wherein the processor is configured to adjust the background of the main flash frame based on the weight matrix.
